(19) United States
(12) Patent Application Publication
(10) Pub. No.: US 2007/0096872 A1
(43) Pub. Date: May 3, 2007

(54) Access control system and method

(75) Inventors: Hung Nguyen, Tallahassee, FL (US); Robert Mayer, Tallahassee, FL (US)

Correspondence Address: WILLIAM H. HOLLIMON, 215 SOUTH MONROE STREET, 2ND FLOOR, TALLAHASSEE, FL, 32301, US

(73) Assignee: GTO, Inc.

(21) Appl. No.: 11/431,848

(22) Filed: May 10, 2006

Related U.S. Application Data
(60) Provisional application No. 60/709,229, filed on Aug. 18, 2005.

(51) Int. Cl. G05B 19/00

(52) U.S. Cl. 340/5.61; 340/5.54

(57) ABSTRACT

An access control system including a remote station that is in communication with both a base station and an access control device, whereby a user located at the remote station can effect the actuation of an access control device directly if the user possesses the proper authorization, or, indirectly, by requesting and receiving an authorization signal from the base station which then allows the user to directly effect actuation of the access control device.

### BACKGROUND OF THE INVENTION

This invention relates to the field of controls for access control devices, and, in particular, to the field of access control systems and methods used to safely control remote operation of access control systems. More particularly, this invention relates to a keypad controller that may be in wired or wireless communication with both a base station located remotely from the keypad and an access control device located proximate to the keypad such that the base station can communicate a first level of authorization to the keypad and the keypad can separately and discretely communicate a second level of authorization to an access control device. This system and method provides increased safety and security for persons and property in the vicinity of an access control device by providing the final control of the actuation of such an access control device to a user located in proximity to the controlled device.

One example of a typical access control device is a gate operator used to open and close a gate that may allow for ingress and/or egress of vehicular or pedestrian traffic. Such a gate operator generally includes an electric motor, a gearbox, a transmission or drive mechanism, and a controller that is usually electronic. In response to a wide variety of inputs, an “open” or “close” signal is communicated to the electronic controller and actuation of the gate from the open-to-closed, or the closed-to-open position may be effectuated. Typically, inputs to the electronic controller may come from a variety of sources. Such sources include an input from transmitter being activated (such as a portable, hand-held type transmitter that may be located in an automobile or attached to a key chain), a keypad or card reader located in close proximity to a gate operator that requires the entry and validation of a security code, the possession of a card with an embedded code, or from a telephone based entry system allowing, for example, the occupant of a home to remotely actuate an access control device in response to a request from a visitor. Other types of access control devices include but are not limited to garage door openers and electronic door strikes.

Typical telephone entry systems allow a person remote from a gate operator or other entry control system to directly authorize actuation of the gate controller or other access control system. In almost all such cases, the person authorizing activation of the gate operator or other access control system is remotely located and does not have direct visual contact with the gate operator or entry control system. Thus, remote activation of gate operators or entry control systems substantially increases the risk of damage to persons or property that may be in close proximity to the access control device when such a device is actuated. Further, such access control devices may themselves be damaged by encountering a variety of obstructions that may interfere with the normal operation of the gate operator or other access control device and that are unseen by a person remotely authorizing actuation.

It is also known in the art to provide a keypad controller, usually located proximate to an access control device, which is capable of communicating an actuation signal to an access control device. These prior art keypad controllers require a person desiring access to enter some form of security code that must be validated by the keypad controller prior to the keypad controller generating and transmitting an authorization signal that authorizes the access control device to actuate. However, if such a person does not have possession of a valid security code, that person cannot cause the access control device to change state. While this functionality is important for preventing unauthorized access, it hinders otherwise authorized users from gaining access. Further, the power supply for these types of keypad controllers is typically hard-wired, significantly increasing the time and expense associated with installation and maintenance. While it is also known to provide a power supply through the use of a battery, such power supplies are typically used only in back-up mode. These battery back-ups are generally subject to only occasional use and, as a result of hysteresis and the normal discharge of battery charge over time, often are non-functional at the very time they are needed. Further, these controllers provide no simple and effective method to test the readiness of the battery power supply without the use of specialized tools and/or disassembly of the controller.

In many circumstances legitimate, one-time access through an access control point is needed by service providers, guests, or delivery persons. Many property owners are reluctant to provide a security code that is effective for more than a one-time use to such persons, or wish to avoid the time and inconvenience of separately pre-programming limited duration codes into the controller. If such a one-time use code is not available or this functionality is not supported by the access control system, a property owner is required to either: 1) provide a valid, long-term security code; 2) leave the access point in a state that allows free access; or 3) to be physically present to actuate the access control device.

To address these problems, some keypad controller entry systems are known to be co-located with a separate telephone or intercom system that allows a person seeking access to establish communications with the owner of, or other person having control over, the access control device. In the event that a person seeking access does not possess or remember a valid security code for inputting into the keypad controller, communications may be established over the separate telephone or intercom system and the owner/controller of the access control device is empowered to directly cause actuation of the access control device.

However, these prior art systems suffer from a number of disadvantages. First, a party remotely authorizing actuation of the access control device is typically located distant from the access control device and does not have any visual indication of the status of the access control device or whether any potential damage to persons or property may occur if the access control device is actuated. Thus, these prior art systems inherently increase the risk of damage to persons or property in proximity to the access control device. Second, the separate, communications portions of these systems are typically hard-wired resulting in substantial installation costs, particularly where the communications systems is retrofitted into an existing facility. Third, these systems do not allow a person remotely located from an access control device to easily provide one-time actuation control to the person located at the keypad controller without providing a valid long-term access code or to expend the time and suffer the inconvenience of establishing and maintaining a list of one-time, or limited duration, use codes. Thus, these systems make it more likely that an unauthorized entry through a controlled access point will occur. Further, these systems lack a reliable back-up or primary battery based power supply, as well as a simple and efficient method for determining the operating status of any such battery power supply. Thus, users of these prior art systems are required to replace batteries more frequently than necessary and/or to suffer untimely battery power failures.

For the foregoing reasons, there is a need for a simple, effective, low-cost, system that: 1) allows the owner/controller of an access control device to remotely authorize a person in proximity to, and generally within sight of, an access control device to effect actuation of the access control device; 2) increases the safety to persons and property in proximity to an access control device by providing a first level of access control system authorization remotely and a second, operational level of access control system authorization locally; 3) allows the owner/controller of an access control device to simply and efficiently provide remote authorization to a person located at a keypad controller for one-time access through an access control device; 4) provides a reliable, real-time indication of keypad controller battery status; and 5) provides a system that accommodates secure wireless communications to reduce the time and expense associated with installation or retrofit of such systems.

### SUMMARY

It is therefore an object of the present invention to provide a system for controlling an access control device that includes a keypad controller located proximate to an access control device, with such keypad controller capable of receiving and verifying security codes, and upon receipt of a valid security code, transmitting an actuation signal to an access control device controller in communication with the keypad controller. It is a further object of the invention to provide a base station located remotely from the keypad controller that is in voice and data communication with the keypad controller and that can provide an authorization signal to the keypad controller. It is a further object of the present invention to provide the keypad controller with two separate, discrete communications systems, such that the keypad controller uses a first communications system to communicate with an access control device and a second communications system to communicate with the base station. It is a further object of the invention to allow all communications to and from the keypad controller to be either wired or wireless and to be securely encrypted. It is also an object of the present invention to allow a person located at the keypad controller, upon receipt of the authorization signal from the base station, to transmit an independent, operational level authorization signal to an access control device without requiring the entry of a standard, valid security code. Another object of the present invention is to provide a battery monitoring system that provides a real-time indication of keypad controller battery status.

These objects are achieved, in accordance with the principles of a preferred embodiment of the invention, by providing an access control system made up of a weather resistant keypad controller, suitable for and designed for mounting on a post or other stationary facility in proximity to an access control device that is to be controlled, and a remote, base station unit that is in communication (wired or wireless) with the keypad controller. The keypad controller contains two, discrete communications systems. The first communication system provides secure, encrypted data communication (wired or wireless) to the controller of an access control device to authorize actuation of the access control device. The second communications system provides secure, encrypted voice and data communications between the keypad controller and a base station located remotely from the keypad controller. These communications channels may be wired, wireless, or a combination of the two. Wireless communication between the keypad controller and the access control device may operate at a different frequency than wireless communications between the keypad controller and the base station. The keypad controller further provides a battery status communication to the base station upon establishing communications between the keypad controller and the base station. The base station then provides a visual indication to a user located at the base station of the keypad controller's battery status.

Because all communications from the keypad controller to the base station and to the access control device may be performed wirelessly, the present invention greatly reduces the installation time and expense associated with running wire from the keypad controller to other devices. Further, this feature allows for the simple, efficient, and inexpensive retrofit of an access control system to include the functionality in the present invention.

A user desiring access through an access control device enters a security code directly into the keypad controller. The keypad controller, through an integrated central processor and memory, validates the entered security code. Upon successful validation, the keypad controller transmits a control signal to the access control device, thereby causing the access control device to actuate. In the event the user does not have a valid security code, the user may initiate voice communications between the keypad controller and the base station. These communications may either be hard-wired or wireless. If the owner/controller of the base station desires to grant the user access permission the owner/controller initiates a data communication from the base station to the keypad controller providing authorization. Upon receipt of this authorization, the keypad controller provides the user a visual indication (typically through an LED) that authorization has been received, and the user may then, by depressing any key on the keypad control (i.e., without having to enter a standard, valid security code) transmit an actuation command from the keypad controller to the access control device and thereby effect a one-time actuation of the access control device. This actuation command may be transmitted to the access control device through either a hard-wired communication route, or through a wireless communication route.

### DRAWINGS

These and other features, aspects, and advantages of the present invention will become better understood with regard to the following description, appended claims, and accompanying drawings wherein:

FIG. 1 is a block diagram illustrating elements of an access control system according to an embodiment of the present invention

FIG. 2 is a front isometric view of the keypad controller (remote station) of the present invention;

FIG. 3 is a front view of the base station of the present invention;

FIG. 4 is a block diagram of the keypad controller (remote station) of the present invention;

FIG. 5 is a block diagram of the base station of the present invention;

FIG. 6 is a rear view of the keypad controller (remote station) of the present invention;

FIG. 7 is an electrical schematic of the base station;

FIG. 8 is an electrical schematic of the keypad controller (remote station);

FIG. 9 is an electrical schematic of the transceiver deployed in the base station and the keypad controller (remote station).

### DESCRIPTION

It is to be understood that the elements or functional modules described in this patent application may be implemented in various forms of hardware, software, firmware, or a combination of these things. It is to be further understood that because some of the components of the present invention are to be implemented as software modules, the actual connections as shown on the figures may differ, depending on the manner in which the invention is programmed. Special purpose processors may also be utilized to implement the invention. Given the teachings of the invention in this patent application, one of ordinary skill in the related art will be able to contemplate these and similar implementations of the elements of the invention.

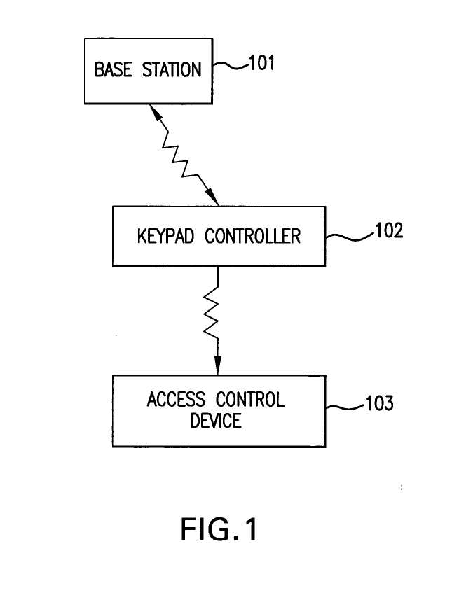

Referring to FIG. 1, a block diagram illustrating elements of the access control device is shown. Base station 101 is shown in wireless communication, at 900 MHz, with keypad controller 102. Alternatively, communications between base station 100 and keypad controller 101 may be hard wired. Access control device 103 represents any of a variety of access control devices that may be controlled through keypad controller 102. Typical access control devices include gate openers, garage door openers, electronic door locks, and the like. Access control device 103 is capable of receiving wireless communications, at 318 MHz, from keypad controller 102. Communications from keypad controller 102 to access control device 103 may also be through a hard wired communications connection. As is known to those skilled in the art, the frequency at which the above described wireless communications occur may readily be varied to suit the needs of a particular application or as required to comply with government regulation.

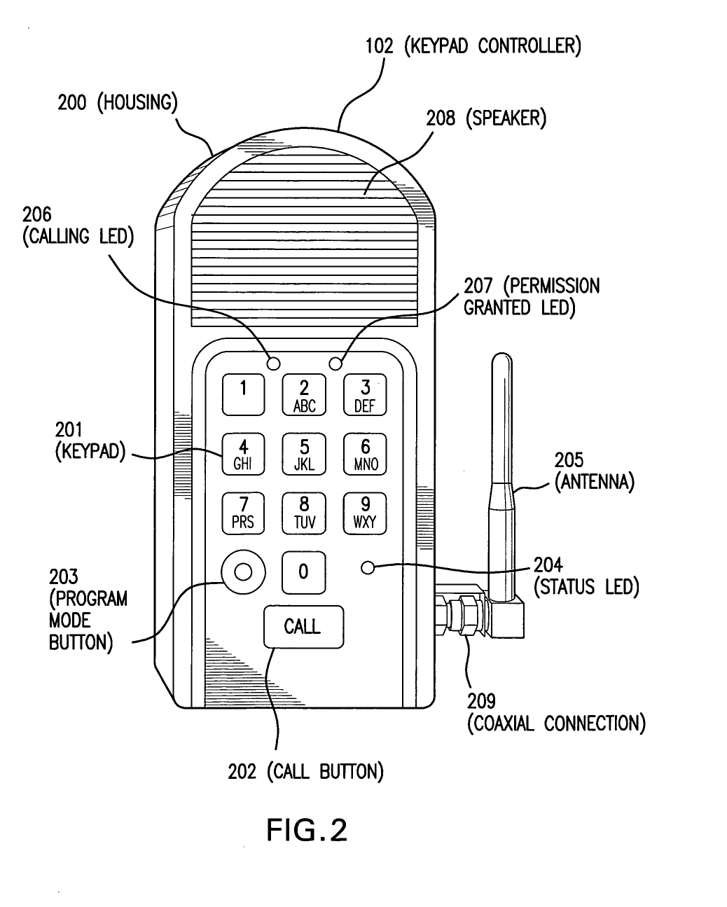

Referring to FIG. 2, a front isometric view of keypad controller 102 is shown. Keypad controller 102 includes housing 200, which is constructed of plastic or other weather resistant material suitable for outdoor installation. Keypad 201 provides a user interface for entry of security codes. Alternatively, the data entry element of the user interface provided by keypad 102 could be provided by other means such as a magnetic card reader, RFID reader, touch screen, biometric data reader, or the like. Call button 202 is used to establish voice communications with base station 101. In this embodiment, a half-duplex circuit is employed providing push-to-talk type functionality. Alternatively, a full-duplex communications link between base station 101 and keypad controller 102 may be employed. Program mode button 202 allows a user to place keypad controller 102 in program mode such that security codes may be stored in memory (not shown) internal to housing 200. Status LED 204 provides a visual indication to a user, i.e., the LED emits, whenever an individual key on keypad 201 is depressed. Antennae 205 connects through coaxial connection 209 and housing 200 to a transceiver (not shown) disposed within housing 200 and is used for wireless communications between base station 101 and keypad controller 102. In the embodiment where hard wired communications between base station 101 and keypad controller 102 are provided, antennae 205 is removed and a coaxial cable (not shown) is connected between coaxial connection 209 and base station 101. Calling LED 206 provides a visual indication that call button 202 has been depressed. Permission granted LED 207 provides a visual indication to a user when a valid security code has been entered or when the owner/controller of base station 101 has authorized access from base station 101. Speaker 208 is integrated into housing 200 and provides audible voice communications transmitted from base station 101.

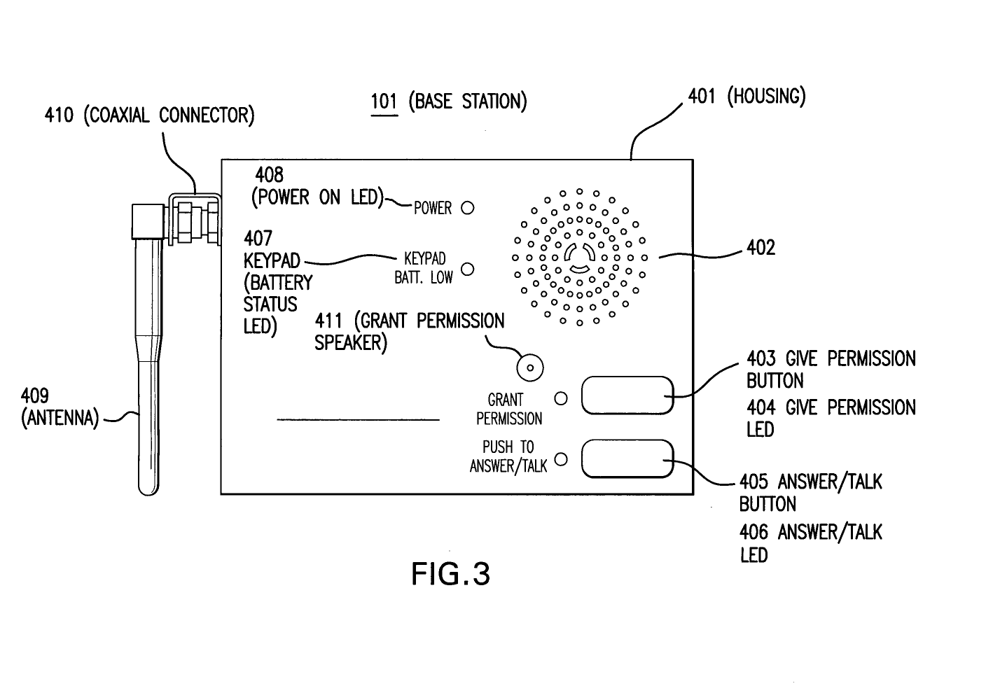

Referring to FIG. 3, a top view of base station 101 is shown. Base station 101 includes base station housing 401 molded from plastic or other suitable material. Speaker 402 provides the audio for voice communications from keypad controller 102. Grant permission button 403 allows the owner/controller of base station 101 to provide an authorization command to keypad controller 102. Grant permission LED 404 provides a visual indication and grant permission speaker 411 provides an audio indication that the authorization command has been communicated to keypad controller 102. Answer/talk button 405 enables voice communications between base station 101 and keypad controller 102. In this embodiment, a half-duplex voice communications circuit is employed. Base station antennae 409 connects through base station coaxial connector 410 and housing 401 to base station transceiver (not shown) disposed within base station housing 401.

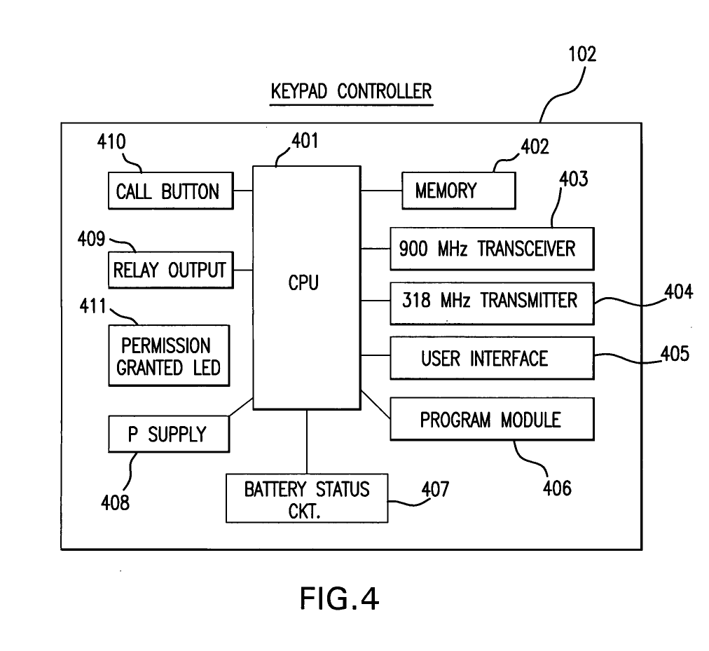

Referring to FIG. 4, a block diagram of keypad controller 102 is shown. CPU 401 controls the overall operation of keypad controller 102. Memory 402 is operatively connected to CPU 401 and is capable of storing up to 25 four digit security codes in non-volatile memory. Transceiver 403 is operatively connected to CPU 401 and preferably operates at 900 MHz to provide voice and data communications between keypad controller 102 and base station 101.

In a preferred embodiment, user interface 405 consists of keypad 201 which allows a user to directly enter a security code into keypad controller 102. Program module 406 allows for the creation and storage in memory 402 of up to 25 unique, four digit, security codes. Each such security code is programmable to have either a limited or a permanent duration. Program module 406 also allows a user to delete security codes that have been programmed and stored in memory 402.

Power supply 408 provides operational power to keypad controller 102 and is, in a preferred embodiment, 6V DC supplied by batteries internal to keypad controller 102. Alternatively, power supply 408 accepts a hard wired 6V DC power from an external source such as access control device 103. In this configuration, the on-board batteries within keypad controller 102 function as back-up to the hardwired source. Battery status circuit 407 monitors the voltage status of on-board batteries 607 within keypad controller 102. In the event keypad controller 102 battery voltage drops below a predetermined threshold, a data signal is communicated to base station 101, and keypad battery status LED 407 emits.

318 MHz transmitter 404 provides wireless communications with access control device 103. Upon entry of a valid security code, 318 MHz transmitter 404 is authorized to transmit a data signal to access control device 103 to effect actuation of access control device 103. Alternatively, upon receipt of an authorization signal from base station 101, 318 MHz transmitter 404 may be authorized by a user located at keypad controller 102 to transmit an actuation signal to access control device 103.

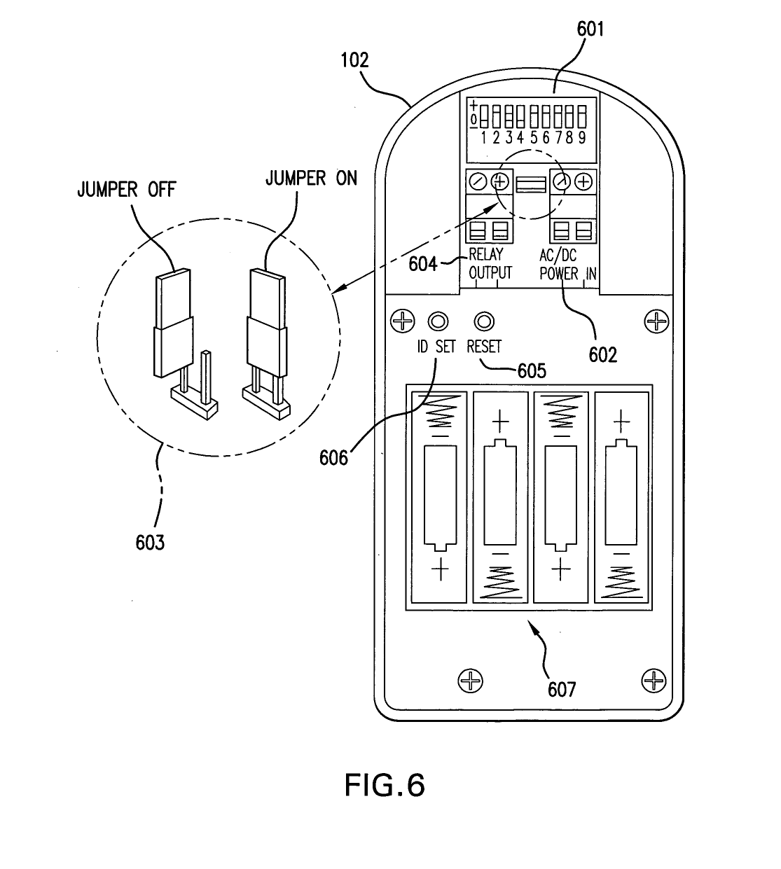

Keypad controller 102 is also configurable to provide hard wired communications to access control device 103. In this embodiment, relay output 409, which is operatively connected to CPU 401, is hardwired to access control device 103. Upon receipt of a valid security code through user interface 405, or upon receipt of a first level authorization signal from base station 101 and input from a user located at keypad controller 102, relay output 409 changes state and communicates an actuation command to access control device 103. Referring to FIG. 6, a rear view of keypad controller 102 is shown. Relay output contact 604 is controlled by the position of jumper 603. In the “jumper on” position, 318 MHz transmitter 404 is disabled and communication from keypad controller 102 to access control device 103 is through a hard wired connection (not shown). DIP switch 601 is a trianary DIP switch used to encode wireless communications from 318 MHz transmitter 404 to access control device 103. A matching trinary DIP switch in access control device 103 must be identically set to receive and decode such communications or, alternatively, access control device 103 must be programmed to decode the signal transmitted by 318 MHz transmitter 404.

Batteries 607 provide power for keypad controller 102. Alternatively, a hard wired power source can be connected at power in terminal 602. In this circumstance, batteries 607 function as back-up power.

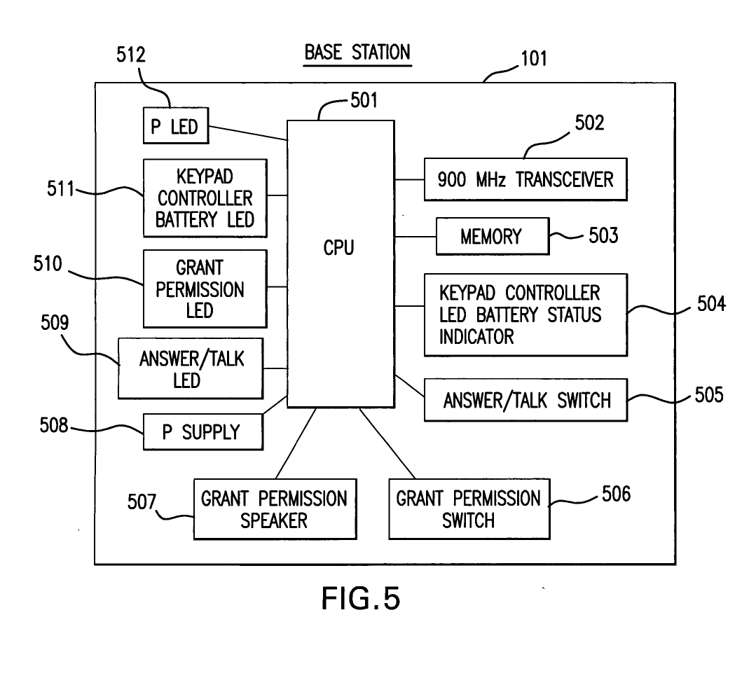

Referring to FIG. 5, a block diagram of base station 101 is shown. Base station CPU 501 controls the overall operation of base station 101. Base station 900 MHz transceiver 502 is operably connected to CPU 501. Base station transceiver 502 provides secure, encrypted voice and data communications with keypad controller 102, and is provided in a matched pair with keypad controller transceiver 403 to ensure that communications are secure and can only occur between a base station 101 and a keypad controller 102 that form a matched set.

Memory 503 is operably connected to CPU 501 and stores a unique identification for the matched pair of transceivers in base station 101 and keypad controller 102. Communications between transceivers 502 and 403 may only occur if keypad controller transceiver 403 communicates the unique identification stored in base station memory 503. Keypad controller battery status indicator LED 504 is operably connected to CPU 501. In the event that the battery voltage of keypad controller 102, as sensed by battery status circuit 407, is below a predetermined threshold, a corresponding signal is generated by keypad controller 102 and transmitted to base station 101. Upon receipt of such a signal, keypad controller battery status indicator LED 504 emits to provide the owner/controller of base station 101 a visual indication of a low voltage condition at keypad controller 102. This feature helps ensure timely replacement of batteries used in keypad controller 102 and avoids the common condition of keypad controller failure due to a lack of battery voltage.

Answer/talk switch 505 is operably connected to CPU 501 and is used to establish voice communications between base station 101 and keypad controller 102. In this embodiment, voice communications are through a half-duplex circuit such that the owner/controller of base station 101 must actuate answer/talk switch 505 to “answer” a call from keypad controller 102, and must de-actuate answer/talk switch 505 to listen to voice communications from keypad controller 102. Answer/talk LED 509 provides a visual indication of the position of answer/talk switch 505 by emitting in two, distinct colors depending upon the position of answer/talk switch 505.

Grant permission switch 506 allows the owner/controller of base station 101 to remotely provide an authorization command to keypad controller 102. Upon actuation of grant permission switch 506, a data signal is transmitted to keypad controller 102 and permission granted LED 411 on keypad controller 102 emits indicating to a user located at keypad controller 102 that access has been granted. At that point and in this embodiment, a user located at keypad controller 102 may effect actuation of access control device 103 by pressing any single button on keypad 201. Grant permission LED 510 provides a visual indication and grant permission speaker 507 provides an audible indication to the owner/controller of base station 101 that grant permission switch 506 has been actuated.

Base station power supply 508 provides operational power to base station 101 and is, in a preferred embodiment, a transformed AC input with a rechargeable battery back-up. Power LED 512 provides the owner/controller of base station 101 with a visual indication of power source by emitting in a first color when base station 101 is powered by transformed AC power and emitting in a second color when base station 101 is powered by back-up battery power.

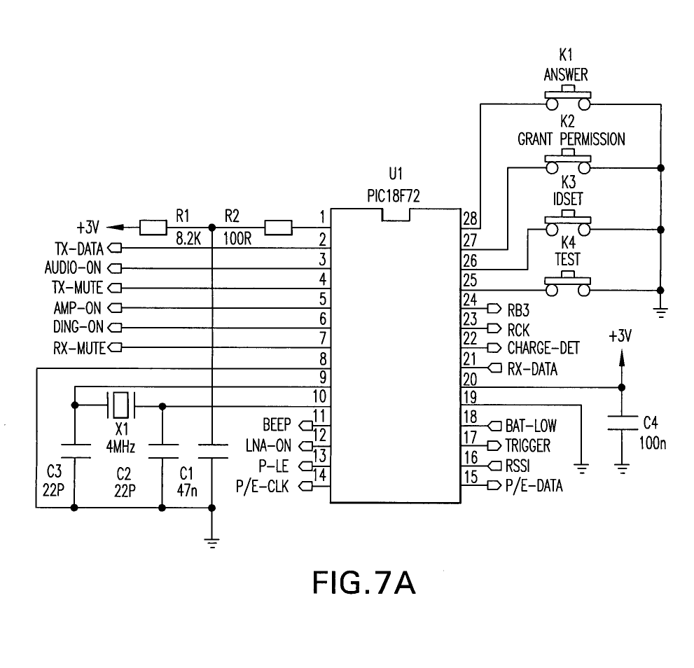

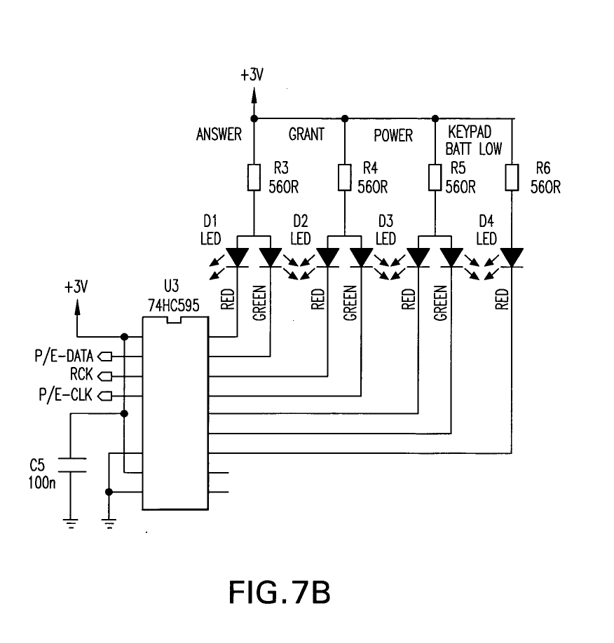

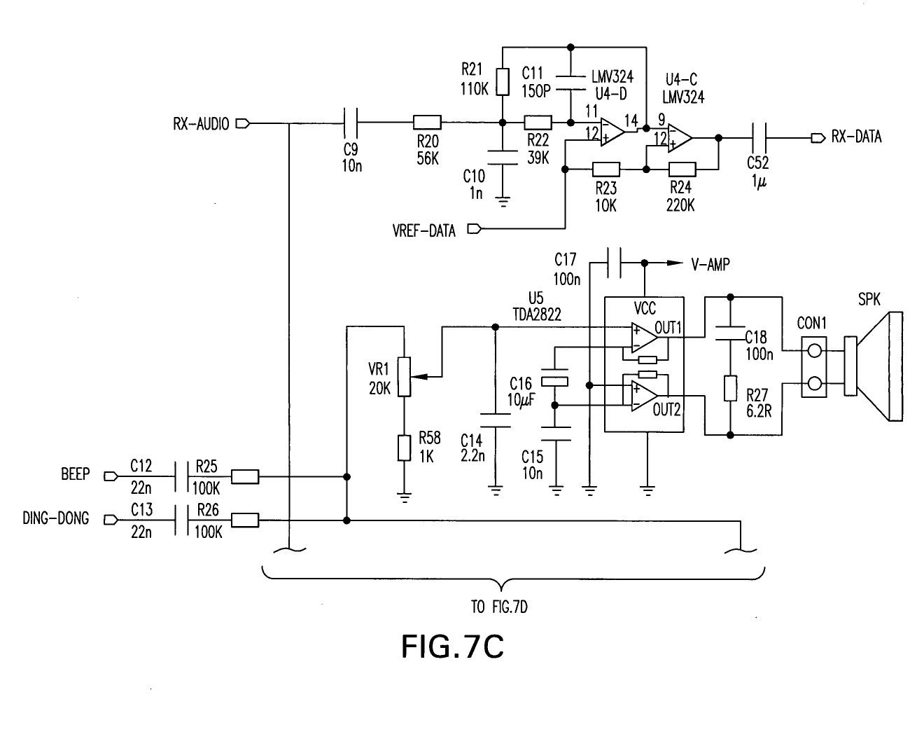

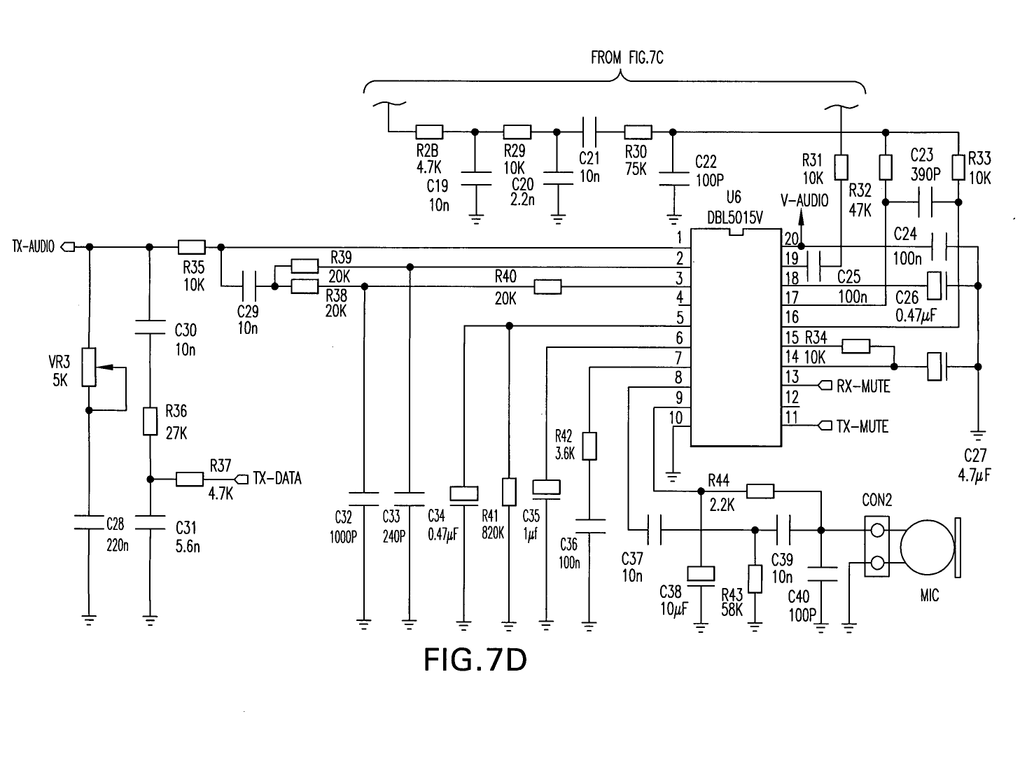

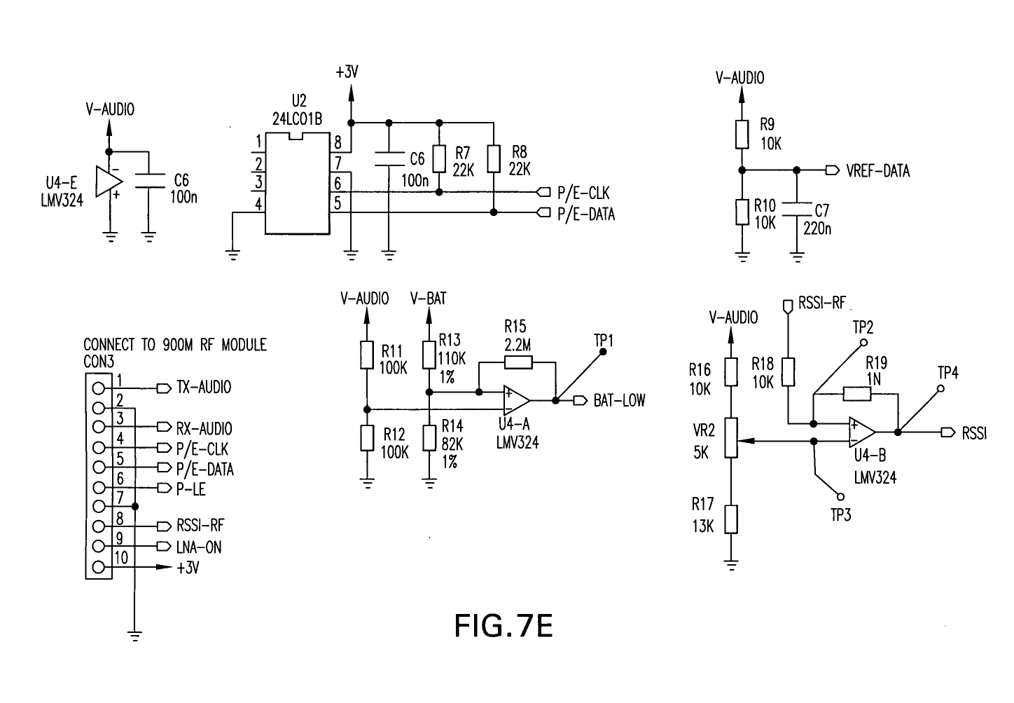

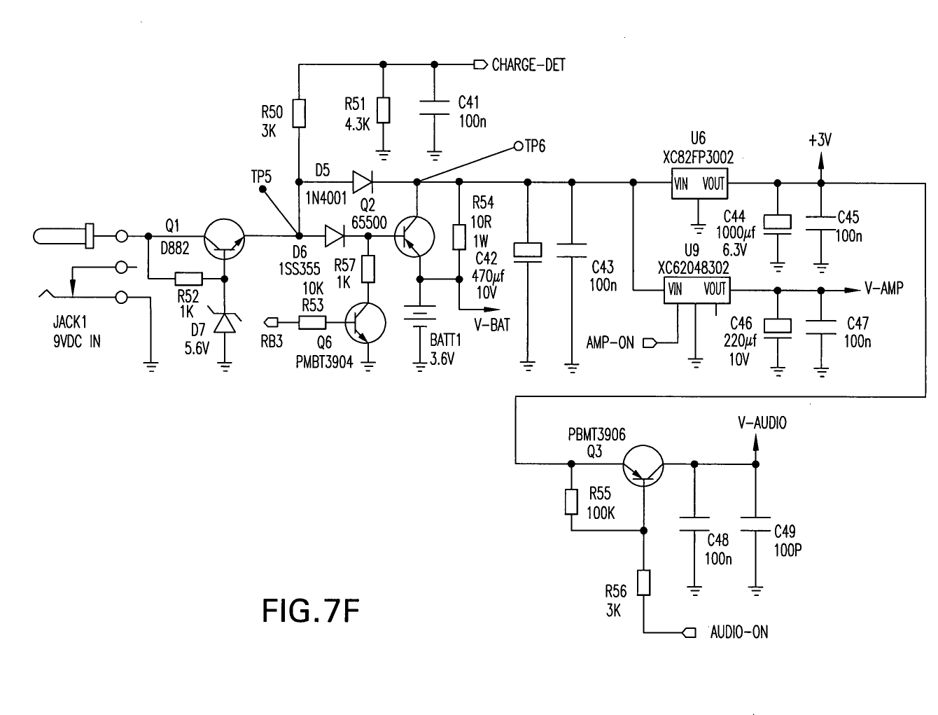

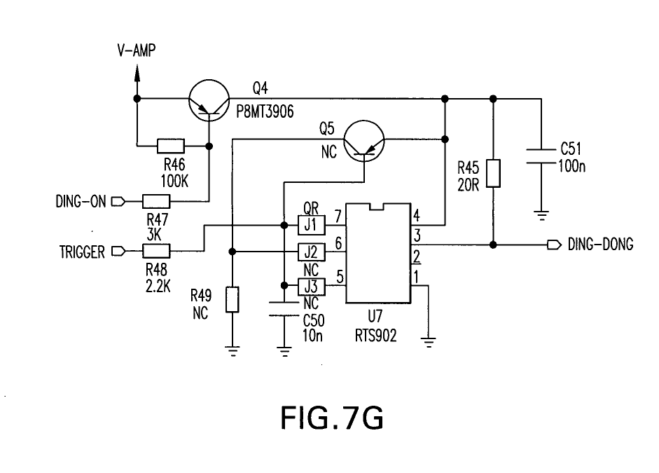

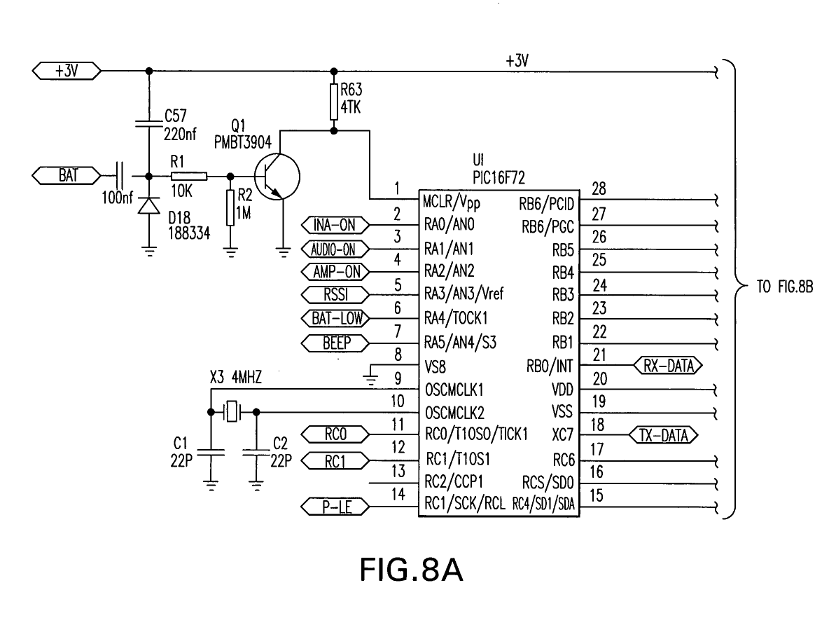

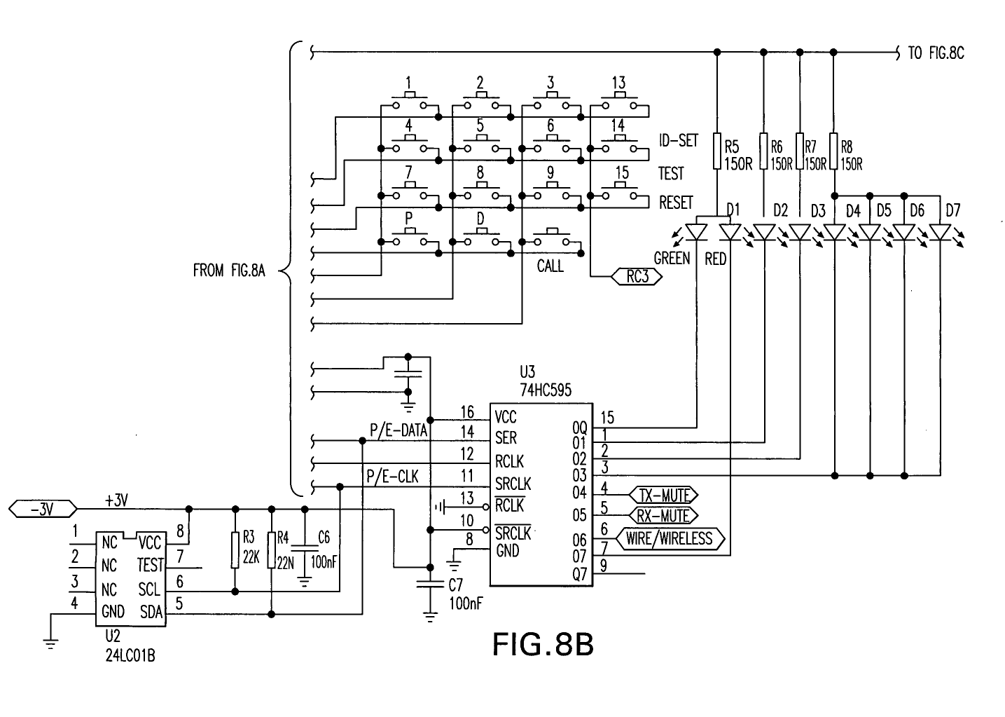

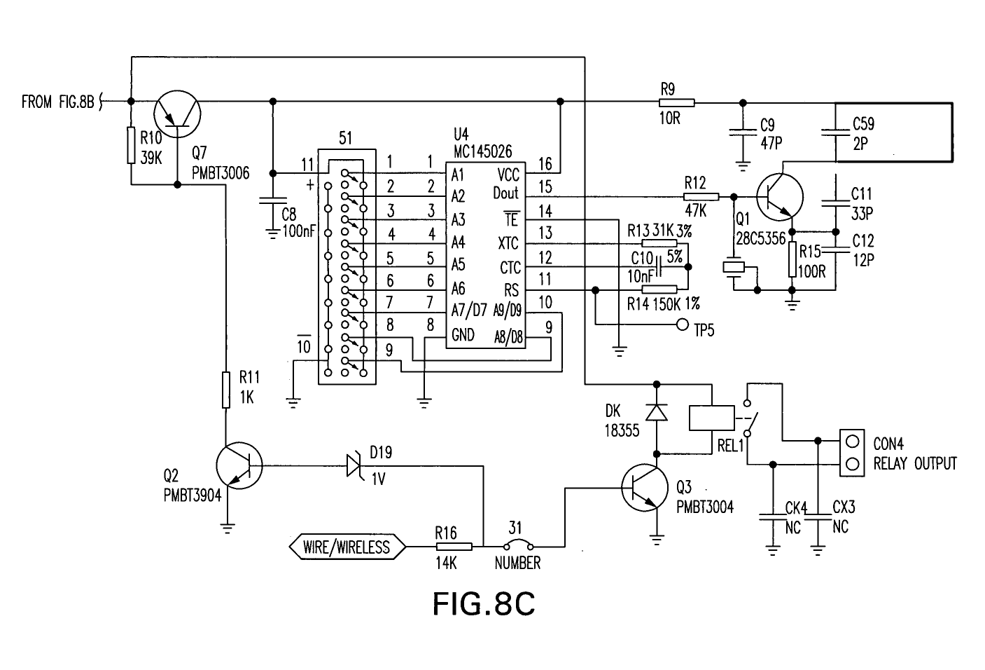

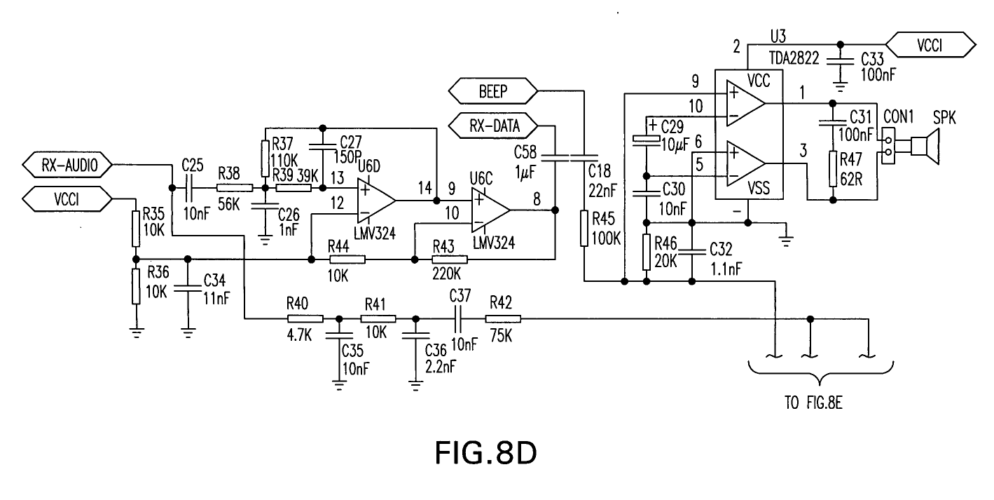

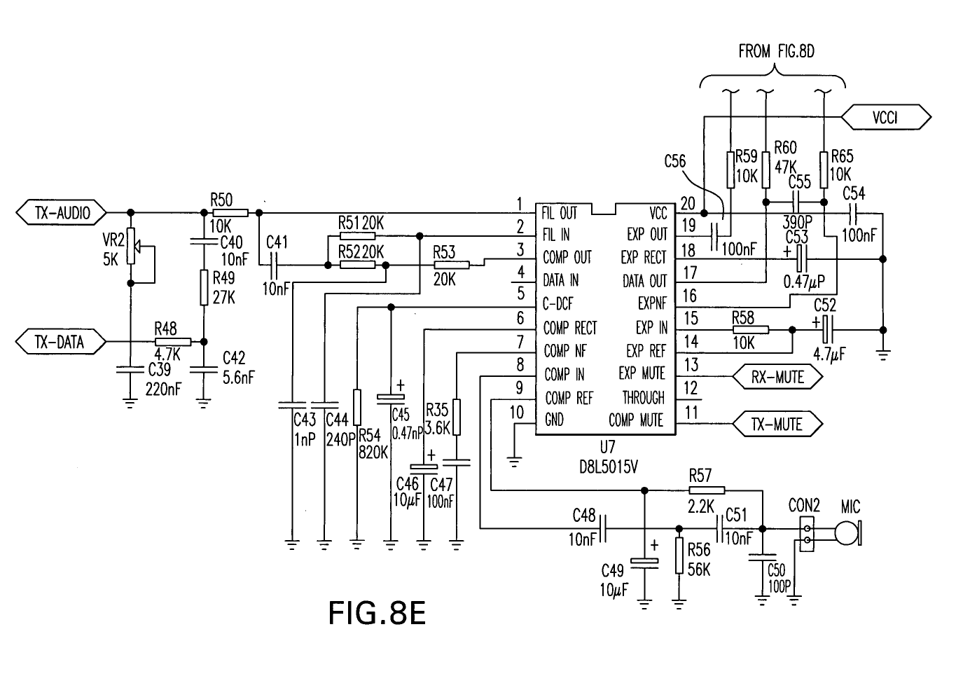

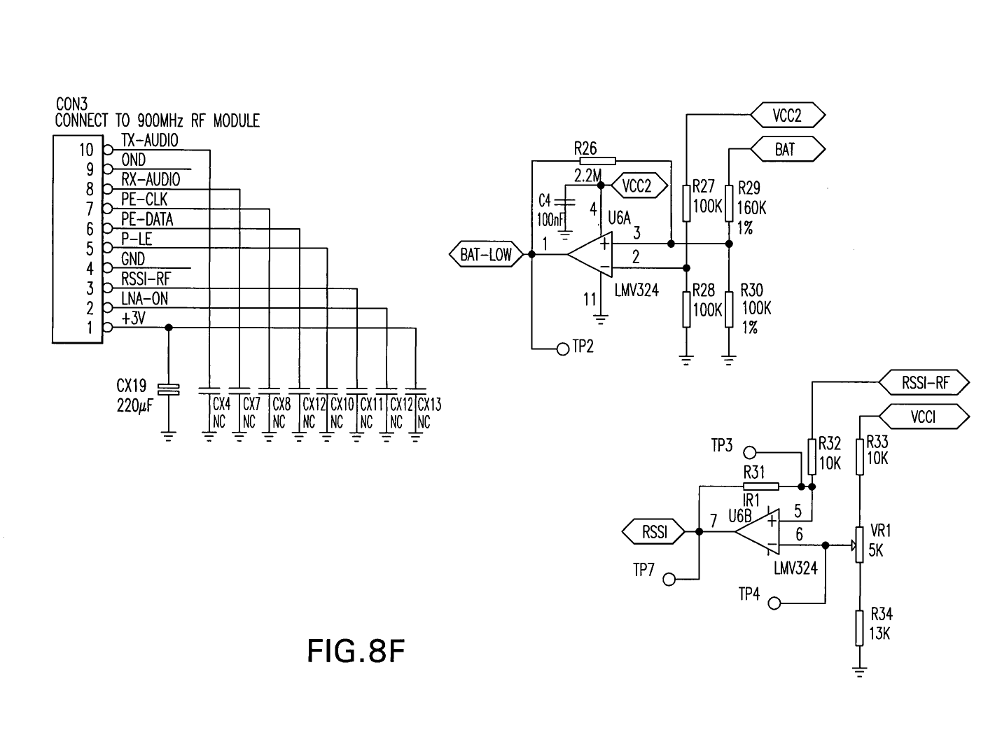

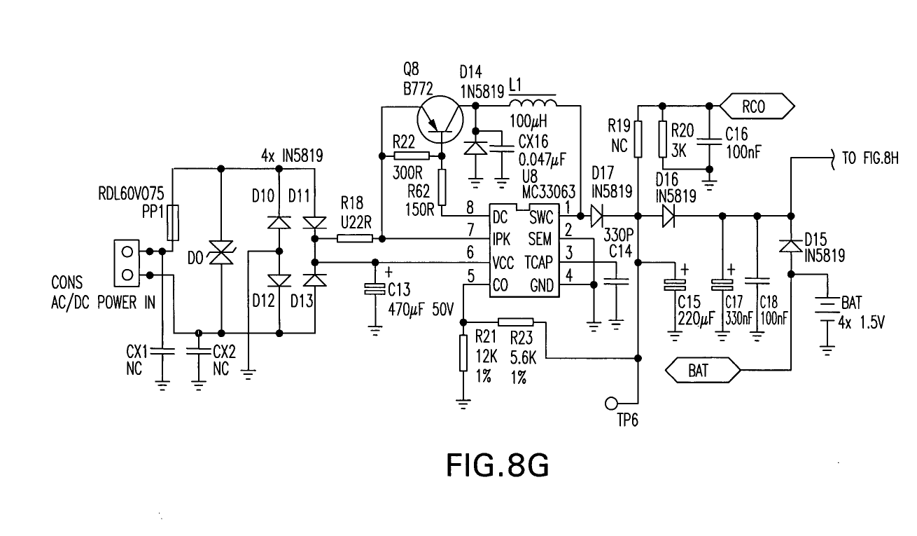

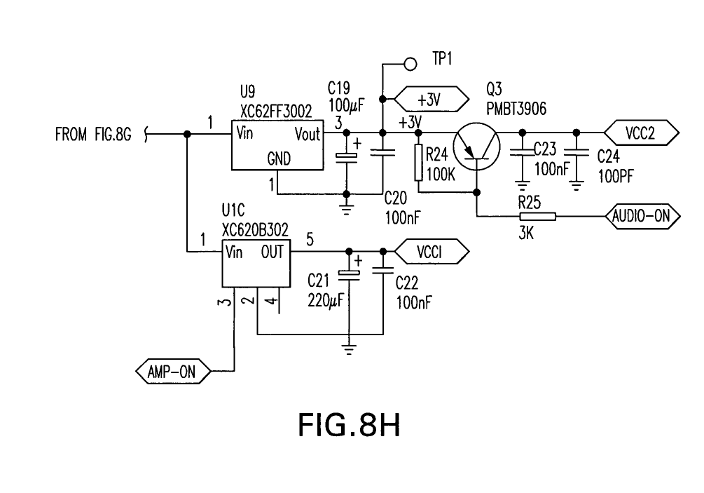

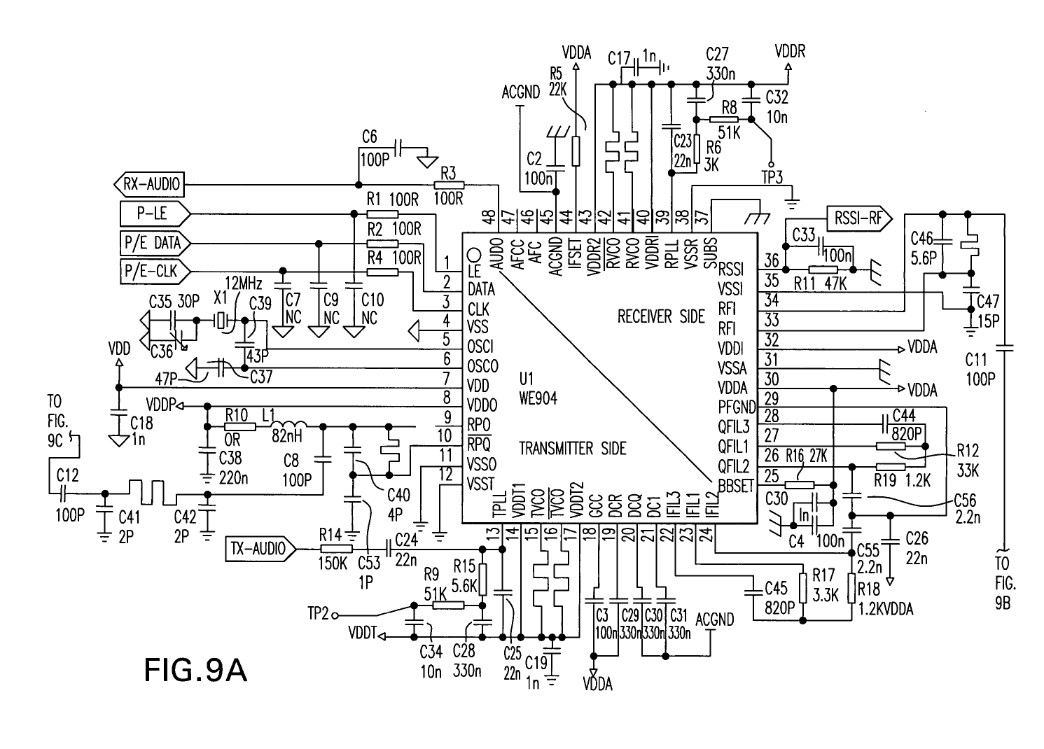

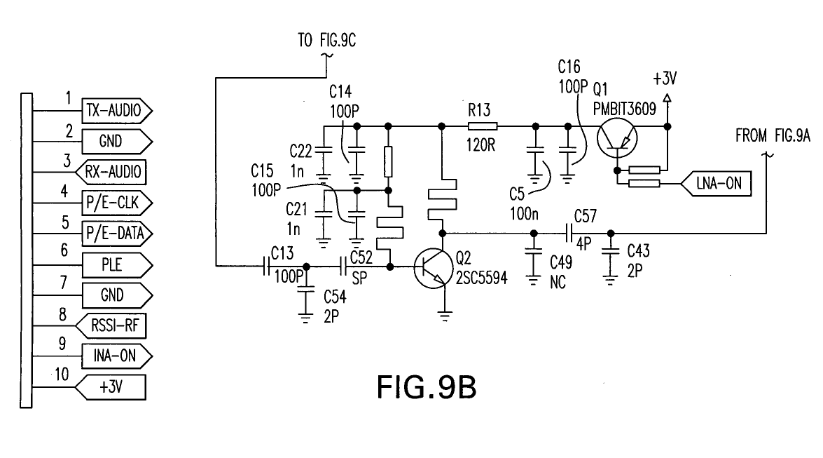

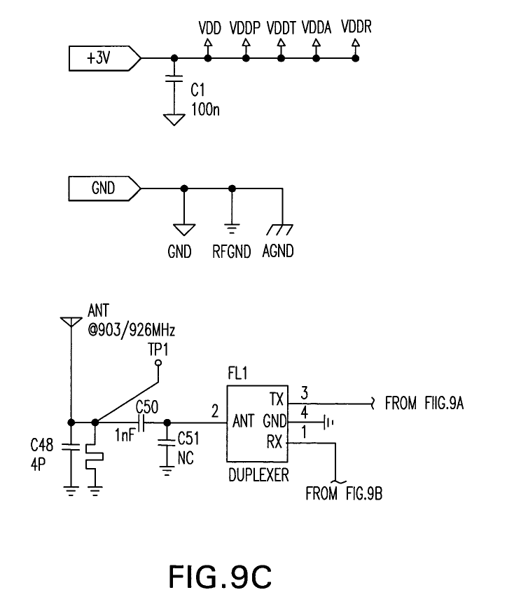

Referring to FIG. 7, FIG. 8, and FIG. 9, an electrical schematic of the base station, the remote station, and the transceiver deployed in the base station and remote station, respectively, are provided.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations, and the same are intended to be comprehended within the meaning and range of equivalents of the appended claims.

What is claimed is:

1. An access control system comprising:
a. a base station;
b. an access control device;
c. a remote station in communication with said base station and in separate communication with said access control device;
wherein, a first user, located at said base station, may selectively provide an authorization command to said remote station thereby enabling a second user located at said remote station to selectively provide an actuation command from said remote station to said access control device thereby effecting actuation of said access control device.

2. The access control system of claim 1 wherein said remote station is in two-way communications with said base station.

3. The access control system of claim 2 wherein said base station is in wireless communication with said remote station.

4. The access control system of claim 3 wherein said remote station includes a visual indication that said authorization command has been received.

5. The access control system of claim 4 wherein said remote station is in wireless communication with said access control device.

6. The access control system of claim 5 wherein said remote station, upon establishing communications with said base station, transmits a battery status to said base station.

7. The access control system of claim 6 wherein said base station includes a visual indication of said battery status.

8. The access control system of claim 7 wherein said base station and said remote station each include a transceiver, each of said transceivers forming a matched pair, whereby communications between said base station and said remote station require said matched pair of said transceivers.

9. An access control system comprising:
a. a base station in wireless communication, at a first frequency, with a remote station;
b. an access control device in wireless communication, at a second frequency, with said remote station;
c. means for communicating an authorization command from said base station to said remote station;
d. upon receipt of said authorization command by said remote station, means for communicating an actuation command from said remote station to said access control device;
wherein a first user, located at said base station, may selectively provide said authorization command to said remote station thereby enabling a second user, located at said remote station, to selectively provide said actuation command from said remote station to said access control device thereby effecting actuation of said access control device

10. An access control system comprising:
a. a base station, said base station including:
i. a first transceiver operable at a first radio frequency capable of transmitting and receiving communications;
ii. a first user interface, said first user interface comprising means for initiating communications, a speaker for making received communications audible, and means for communicating an authorization command;
b. a remote station, said remote station including:
i. a second transceiver operable at said first radio frequency capable of transmitting and receiving communications between said base station and said remote station, and capable of receiving said authorization command;
ii. a transmitter operable at a second radio frequency and capable of communicating an actuation command;
iii. a second user interface;
c. an access control device, said access control device including:
i. a receiver operable at said second radio frequency and capable of receiving said actuation command from said remote station;
ii. upon receipt of said actuation command, means for effecting actuation of said access control device.

11. The access control system of claim 10 wherein said first transceiver and said second transceiver constitute a matched pair.

12. The access control system of claim 11 wherein communications between said base station and said remote station can only occur between said matched pair of said transceivers.

13. The access control system of claim 12 wherein said second user interface further includes means for providing a visual indication that said authorization command has been received by said remote station.

14. The access control system of claim 13 wherein said second user interface further includes means for initiating communications to said base station.

15. The access control system of claim 14 wherein said second user interface further includes a keypad for entering a security code, whereby, upon a validation of said security code, said remote station is authorized to transmit said actuation command to said access control device.

16. The access control system of claim 13 wherein said second user interface further includes a magnetic card reader for receiving a security code, whereby, upon validation of said security code, said remote station is authorized to transmit said actuation command to said access control device.

17. The access control system of claim 13 wherein said second user interface further includes an RFID reader for receiving a security code, whereby, upon validation of said security code, said remote station is authorized to transmit said actuation signal to said access control device.

18. The access control system of claim 13 wherein said second user interface further includes a biometric data reader for receiving a security code, whereby, upon validation of said security code, said remote station is authorized to transmit said actuation command to said access control device

19. A method of controlling an access control device comprising:
a. providing a remote station proximate to said access control device;
b. providing a base station remote from said access control device;
c. providing means for communicating an authorization command from said base station to said remote station;
d. providing means for providing a visual indication on said remote station that said authorization command has been received by said remote station;
e. providing means for monitoring a battery status of a battery providing power to said remote station;
f. upon receipt of said authorization command by said remote station, providing means for communicating an actuation command from said remote station to said access control device;
whereby, a first user located at said base station, may selectively transmit said authorization command to said remote station thereby enabling a second user located at said remote station to selectively transmit said actuation command from said remote station to said access control device thereby effecting actuation of said access control device.

20. The method of claim 19, wherein said step of providing means for communicating an authorization command includes providing a matched pair of transceivers, wherein one of said transceivers is disposed within said remote station and the other of said transceivers is disposed within said base station.
